(19) United States
(12) Patent Application Publication
(10) Pub. No.: US 2008/0022012 A1
(43) Pub. Date: Jan. 24, 2008

(54) Peer-to-peer file download system for IPTV network

(76) Inventor: Matrix Xin Wang, QingDao (CN)

Correspondence Address: MCCORMICK, PAULDING & HUBER LLP, 185 ASYLUM STREET, CITY PLACE II, HARTFORD, CT, 06103, US

(21) Appl. No.: 11/540,388

(22) Filed: Sep. 29, 2006

(30) Foreign Application Priority Data
Jul. 20, 2006 (CN) 200610107536.9

(51) Int. Cl. G06F 15/16; G06F 15/173

(52) U.S. Cl. 709/238; 709/207

(57) ABSTRACT

In an IPTV or other network, a server terminal is interconnected with a number of client/peer terminals. For peer-to-peer file downloads, a data file having multimedia content (e.g., a television show) is split into a number of portions for distribution among the peer terminals. The size of each file portion increases according to the chronological order of the multimedia content, such that the first data file portion (containing the beginning of the content) is the smallest, and the last portion (containing the end of the content) is the largest. Having been provided with their network locations, a terminal obtains the file portions in either a sequential mode, where the file portions are obtained in correspondence to the sequential or chronological order of the multimedia content, or a random mode, where the file portions are obtained irrespective of the chronological order of the multimedia content.

This application is entitled to the benefit of and claims foreign priority under 35 U.S.C. §119 from Chinese Patent Application No. 200610107536.9, filed Jul. 20, 2006, the disclosure of which is hereby incorporated by reference.

### FIELD OF THE INVENTION

The present invention relates to communications and, more particularly, to file transfer services on a packet data or other communication network.

### BACKGROUND OF THE INVENTION

In an IPTV (Internet protocol television) network, television content is delivered to consumers using communication technologies more commonly associated with the Internet and similar networks. Thus, instead of using traditional delivery means such as analog radio-frequency transmissions through a co-axial cable or out over the air, digital television services are delivered to subscribing consumers over a broadband Internet connection. In FIG. 1A, for example, an IPTV network 10 includes a number of end-user client terminals 12a-12e and one or more television content or other IP video/media server terminals 14. The terminals are electronic devices capable of communicating over a network, and may include, for example, home or business computer terminals 12a, 12c, IP/network-configured television units 12b, 12d, and multimedia-capable wireless units 12e. The terminals 12a-12e, 14 are connected to a network 16, e.g., the Internet, in a standard manner such as a network interface card. For connection to the network and receiving television program files or other IP multimedia data, each television unit 12b, 12d may include a set top box 18a and a standard television monitor 18b. The set top box decodes IP data and converts it into standard television signals compatible with the television monitor 18b. The server terminal 14 includes a database and/or mass storage 20 such as a hard disk or disk array. Stored in the database are a number of data files 22a-22c, each of which is a multimedia data file (e.g., containing video and audio data) with television content, such as an episode of a television show.

For live television, real time-generated multimedia data is broadcast or multicast over the Internet 16, with client terminals 12a-12e accessing the data according to a pre-set network location or other signaling scheme. (In other words, the end-user terminals 12a-12e are provided with information for accessing and decoding the broadcast IP data stream.) For downloading static or pre-recorded television content files 22a-22c, such as for “video on demand,” the client terminals 12a-12e contact the server terminal 14 over the network 16, in a standard manner, for obtaining selected data files 22a-22c. After one or more optional administrative functions, the requested files 22a-22c are transferred over the network 16 to the client terminals 12a-12e. According to the Internet protocol, the files 22a-22c will typically be broken into packets for transmission over the network, and then reassembled at the client end for storage and use. The video/audio or other multimedia data may be encoded according to a standard MPEG2 or MPEG4 format, which is delivered as a data stream 24 to end-user terminals individually or to multiple end users simultaneously by way of an IP multicast.

Some IPTV networks, such as the network 26 shown in FIG. 1B, utilize a “peer-to-peer” or “P2P” filing-sharing configuration. Here, the client terminals 12a-12e (sometimes referred to as “peer nodes”) are connected to the network 16 in a similar manner as described above. The peer nodes 12a-12e are provided with a means for determining which multimedia data files are stored on each node. For example, each node may be provided with the addresses of the other nodes for obtaining lists of the multimedia data files (e.g., television-content data files) stored on the other nodes. When a file of interest is found on one of the lists, the two nodes establish an ad hoc communication connection (e.g., the connection is generated just for the purposes of transferring a file), and the file is transferred “directly” from one node to the other. That is, the file is transferred directly except for any ephemeral interconnection points required for data transfer over the network 16. (For example, in a typical Internet connection, data is sent from an originating terminal through a chain of intermediate terminals until the data reaches its destination.) Alternatively, one of the peer nodes 12f (acting in a capacity similar to a server terminal 14) may include a general index 28 containing a plurality of listings 30. Each listing identifies a data file and the network address(es) of the peer node(s) on which the data file is stored. For a user to find a particular data file, the index 28 is accessed from the user's peer node/terminal. Once the address of the file is found, an ad hoc connection is established between the user's node and the peer node on which the file is stored. The file is then directly transferred between the two nodes over the network 16.

In another, more common P2P configuration, multimedia data files are split into many equal pieces/portions 32a-32d, typically on the order of a thousand per file. (For example, a data file containing a two hour-long television show could be split into a thousand portions, each representing about 7.2 seconds of multimedia content.) Although the file portions may originate in the first instance with a server 14, they will eventually be distributed among a number of peer terminals 12a-12d. When another terminal 12e desires to obtain the data file, the locations of the data file portions 32a-32d (which together comprise the complete data file) are obtained as described above, and each peer terminal 12a-12d is contacted for obtaining its respective data file portion(s). This may involve “bartering” for file portions by receiving and transferring them in a “tit for tat”-like manner. The data file portions 32a-32d may be viewed in “real time” (e.g., as they are received), or they may be stored and then reassembled for viewing the content in the original data file.

When a peer-to-peer file transfer model is used in an IPTV or similar network, equal-sized data file portions are distributed among a number of peer terminals. For downloading files, peer terminals are configured to initially obtain the first portion of a data file, instead of a randomly selected data file portion. After obtaining the first data file portion, a peer terminal subsequently obtains the sequentially-sequenced portions of the data file, that is, the file portions are obtained in order of sequential multimedia content. This is because the data file content is most frequently viewed in a real-time mode, meaning that the first portion of the multimedia data content (e.g., the first portion of a television show) is first viewed, followed by sequential data file portions, e.g., the remaining portions of a television show, in order. For users desiring to view the media content after downloading the entire data file, however, sequential access and transfer may not be the most efficient or speedy transfer available. Additionally, considering that users oftentimes view only the first portion of a multimedia data file (e.g., to see if it contains content they are interested in viewing further), it may be a waste of communication bandwidth to require users to initially download data file portions as large as those later in the content sequence.

### SUMMARY OF THE INVENTION

Accordingly, an embodiment of the present invention relates to a system for peer-to-peer file transfer or download in an IPTV or other network, wherein the initial portions or sections of a data file for peer-to-peer transfer are smaller than the latter sections of the data file. Because the first sections are smaller, this reduces overall bandwidth usage in the network from users who only download the initial sections for purposes of screening or assessing the data file content. The system may also have a “random” transfer mode, where data file sections are transferred “out of order.” This mode may be used in instances where real-time viewing of the data file content is not required, for decreasing the amount of time required for transferring the data file.

The file transfer system includes a server terminal and a plurality of client/peer terminals, which communicate over the network. By “terminal,” it is meant an electronic device capable of communicating over a network, including, for example, computers, network-connected television units, wire-line connected communication devices such as telephones and enhanced/multimedia-capable telephones, and/or wireless units such as mobile phones, wireless PDA's, wireless devices with high-speed data transfer capabilities, such as those compliant with “3-G” or “4-G” standards, “WiFi”-equipped computer terminals, and the like. In operation, the server splits a multimedia content data file into a plurality of data file sections for eventual distribution among the peer terminals. (By “multimedia” content, it is meant at least audio and video content.) At least some of the data file sections are increased in size in correspondence to the sequential order of the multimedia content, e.g., the data file sections containing the first chronologically-ordered portions of the multimedia content are smaller than those containing the later chronologically-ordered portions of the multimedia content. For obtaining the data file portions, the server terminal (or an agent of the server) transmits the network locations of the data file portions to a requesting peer terminal. By “network location,” it is meant the addresses or other locations of the data file portions, the peer terminals having the data file portions stored thereon, or the like.

In another embodiment, the data file section with the first chronological or other sequential portion of the multimedia content is sized at the smallest level of the data file sections. By “smallest level,” it is meant that there may be other data file sections of the same size, but none smaller. Additional, the data file section with the last chronological or other sequential portion of the multimedia content is sized at the largest level of the data file sections, that is, there may be other data file sections of the same size, but none larger.

In another embodiment, the size of the data file sections is based on a linear increase function in correspondence to the sequential order of the multimedia content. For example, the linear function may be configured such that the first data file section (containing the first chronologically-ordered portion of the multimedia content) is the smallest, the last data file section (containing the last chronologically-ordered portion of the multimedia content) is the largest, and the size of each data file section between the two is stepwise increased in a linear manner.

In another embodiment, the system includes a tracker module. The tracker module is a network-connected software- and/or hardware-based application or program, acting as an agent of the server terminal, for carrying out certain communication and other functions of the file transfer/download system. In operation, the server terminal and/or tracker module transmits the network addresses or other locations of the data file sections to a first peer terminal desirous of obtaining the data file. The data file sections are stored on one or more of the other peer terminals. Based on the locations, the first peer terminal obtains the data file sections from the other peer terminal(s), in a peer-to-peer manner. The peer terminals may transmit accounting data to the server terminal and/or to the tracker module. The accounting data relates to the transfer of the data file sections between the peer terminals over the network. For example, the accounting data may include a data transfer rate and the amount of data transferred over the network.

In another embodiment, the accounting data is automatically securely generated and transmitted during or subsequent to when the data file sections are obtained or transferred. By “automatically,” it is meant without user input or initiation, and by “securely” it is meant without the possibility of user intervention or modification, including possible secure transmission over the network. For this purpose, the client/peer terminals may be provided with a client module (e.g., a software- and/or hardware-based application or program) that coordinates, from the client/peer terminal end, (i) communication with the server terminal and/or tracker module, (ii) peer-to-peer file transfer, and (iii) generating and transmitting the accounting data.

In another embodiment, the accounting data is used by the server terminal for generating billing data, e.g., based on the data transfer rate and/or data transfer volume. By “billing data,” it is meant information/data relating to monetary or similar charges (e.g., credits or debits) applied against a user or user account. Typically, users who obtain file sections from a peer terminal are charged a fee for the file transfer. The peer terminals that transmit the file sections may be given credits for transmitting the file sections.

In another embodiment, the establishment of a secure account on the server is required for using the system for peer-to-peer file transfer. By “secure account,” it is meant an account (e.g., grouping of related data organized under an account name), the access of which is restricted based on security features such as account identifier and password protection. After establishing an account, for obtaining a data file the client terminal accesses the account on the server. Subsequently, the client terminal accesses a database on the server for obtaining an information file from the server. The information file is associated with the data file, and may include information relating to the data file. The information file may also include a network address or other location of the tracker module for obtaining the locations of the data file sections from the tracker module. Typically, the tracker module will have the most up-to-date information regarding the location of each section/portion of the data file.

In another embodiment, the peer terminals that are downloading the data file sections will contact the tracker module(s) periodically, informing the tracker module(s) about which pieces/sections of the data file are already downloaded and available for other peer terminals to download.

In another embodiment, the client module is configured for dual mode file transfer, based on user selection or otherwise. Here, the data file portions are obtained according to either a sequential transfer mode or the “random” transfer mode. In the former, the data file portions are obtained in correspondence to the sequential order (e.g., chronological order) of the multimedia content. That is, the first data file portion to be obtained is the one with the first chronological portion of the multimedia content. In the random transfer mode, the data file portions are obtained irrespective of the sequential chronological order of the multimedia content, that is, the data file portions may be obtained “out of order.” Typically, the selection process will not be truly random, but will instead be pseudo-random, or based on factors not relating to file content such as location in the network, available bandwidth, or the like.

As should be appreciated, the system utilizes a peer-to-peer network model for file download, and an account-based client-server network model for managing file downloads and gathering billing information. The system is efficient in terms of file transfer while maintaining accuracy, security, and accountability in terms of network bandwidth usage and billing. Because of the linearly increasing file portion sizes, users who only obtain the first portion of a television show (or other multimedia content), e.g., for evaluation purposes, are not required to needlessly download “large chunks” of the content, which may waste network bandwidth. The dual mode file transfer allows users who do not wish to view file content in “real time” to take advantage of non-sequential downloads, which may be more efficient and/or faster in terms of network bandwidth usage.

### BRIEF DESCRIPTION OF THE DRAWINGS

The present invention will be better understood from reading the following description of non-limiting embodiments, with reference to the attached drawings, wherein below:

FIGS. 1A and 1B are schematic views of file transfer/download systems according to the prior art;

FIGS. 2A-2D are schematic views of a file download system according to an embodiment of the present invention;

FIG. 3 is a schematic view showing message flow in an embodiment of the file download system; and

FIGS. 4A and 4B are flowcharts showing the file download system in operation, according to an embodiment of the present invention.

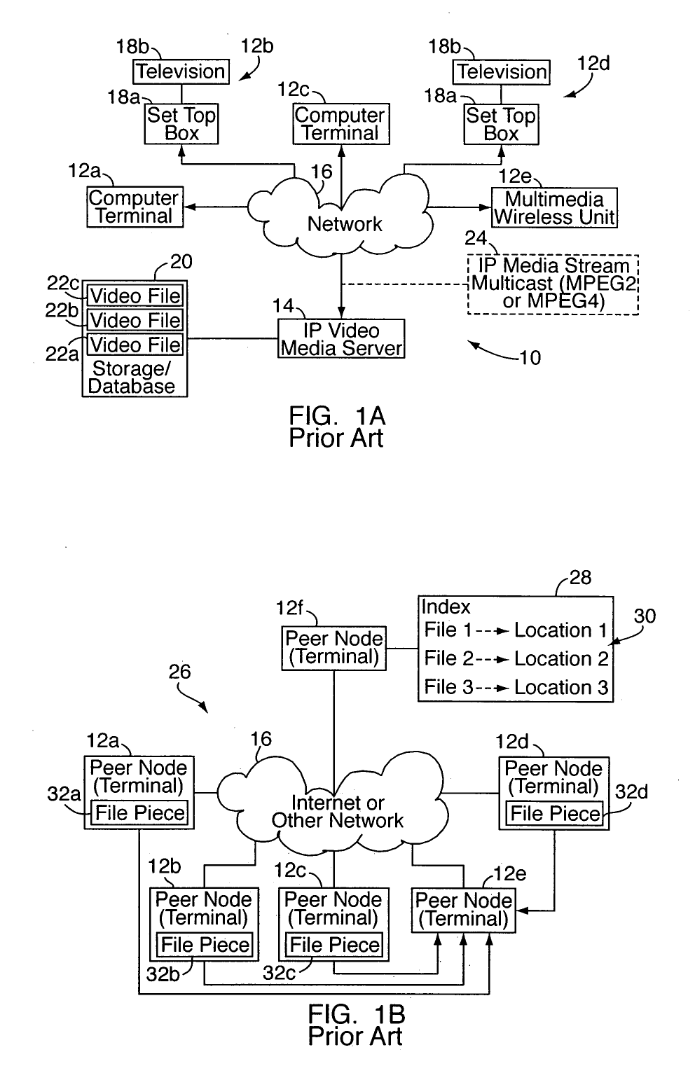

### DETAILED DESCRIPTION

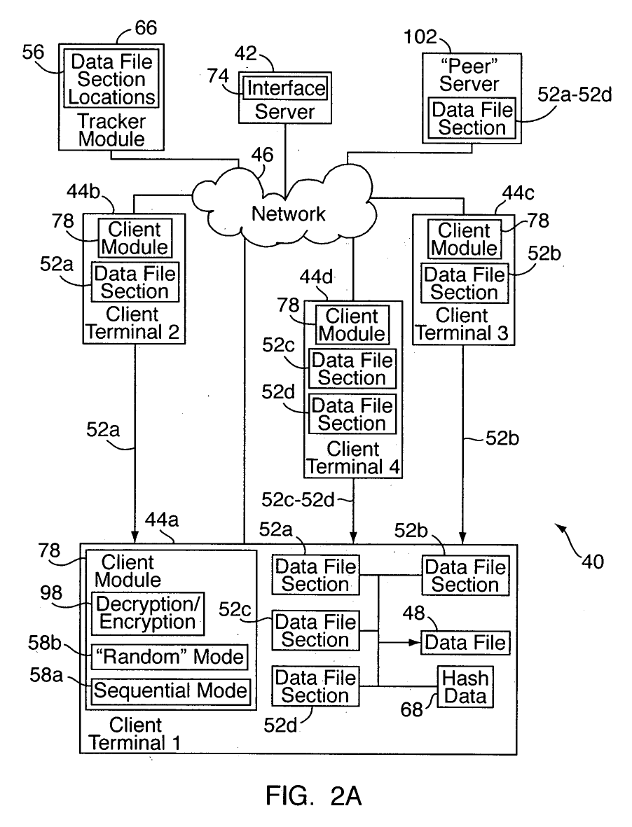

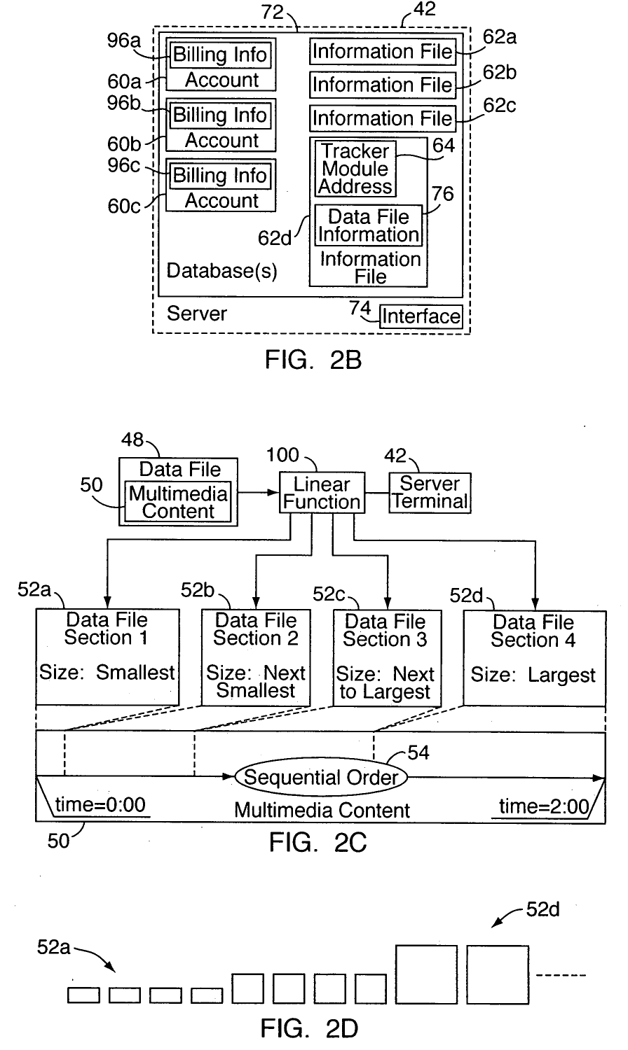

With reference to FIGS. 2A-4B, a peer-to-peer file transfer or download system 40 includes a server terminal 42 and a number of client or peer terminals 44a-44d interconnected by a network 46. The terminals 42, 44a-44d may form a de facto IPTV network. For peer-to-peer file downloads, a data file 48 having multimedia content 50 (e.g., audio/video content such as an episode of a television show) is split into a number of portions or sections 52a-52d for distribution among the peer terminals 44a-44d. The size of each file section 52a-52d increases according to the chronological or other sequential order 54 of the multimedia content 50, such that the first data file section 52a (with the first sequential portion of the content, e.g., the beginning of a television show) is the smallest in size, and the last data file portion 52d (with the last sequential portion of the content, e.g., the end of the television show) is the largest in size. Having been provided with the network locations 56 of the file sections 52a-52d, one of the peer terminals 44a obtains the file sections 52a-52d from the other terminals 44b-44d in a peer-to-peer manner. The peer terminal 44a may be configured for dual mode file transfer. Here, the data file sections 52a-52d are obtained according to either a sequential transfer mode 58a or a “random” transfer mode 58b, based on user selection or otherwise. In the sequential transfer mode 58a, the data file sections 52a-52d are obtained in correspondence to the sequential order 54 (e.g., chronological order) of the multimedia content 50. That is, the data file section 52a having the first sequential portion of the multimedia content 50 is the first to be obtained, followed by the other file sections 52b-52d in order. In the random transfer mode 58b, the data file sections 52a-52d are obtained irrespective of the sequential order of the multimedia content, that is, the data file sections 52a-52d may be obtained “out of order.”

For one of the client/peer terminals 44a to obtain a data file 48 (and data file sections 52a-52d) through the system 40, the client terminal 44a may access the server 42 through a pre-established account 60a. Typically, each client terminal 44a-44d will have an account 60a-60c on the server 42, with the establishment of an account being required for using the system 40. The client terminal 44a obtains an information file 62d associated with the data file 48, which is one of a plurality of information files 62a-62d on the server, one for each data file available for download. The information file 62d contains the network address or other location 64 of a tracker module 66. The client terminal 44a accesses the tracker module 66 to obtain the network locations 56 of the terminals 44b-44d that have the data file sections 52a-52d stored thereon. (Alternatively, the locations 56 may be contained in the information file 62d.) If more than one terminal has the same data file section, the client terminal 44a chooses among the available choices. Based on the locations, the client terminal 44a obtains the sections 52a-52d of the data file 48 from the terminals 44b-44d, in a peer-to-peer manner. That is, the client terminal 44a selects and contacts the peer terminals 44b-44d for obtaining the data file sections 52a-52d, wherein after being contacted by the terminal 44a the terminals 44b-44d transmit the data file sections 52a-52d to the terminal 44a over the network 46. In the sequential transfer mode 58a, the data file sections 52a-52d may be executed for playback as soon as they are received, for real time viewing of the multimedia content 50. In the random transfer mode 58b, once all the data file sections/portions are obtained, the data file sections 52a-52d may be verified and re-assembled into the data file 48 according to hash information/data 68 made available to the client terminal 44a. The hash data is data used for verifying the data file sections 52a-52d, for reassembling the data file portions 52a-52d into a unitary file 48, and/or for classifying the data file portions 52a-52d for purposes of quick and efficient database storage and retrieval. The hash data 68 may be obtained from the information file 62d associated with the file 48.

As should be appreciated, the exact manner in which a terminal 44a arranges for obtaining the data file portion locations 56 from a server 42, and the amount of user involvement in this process, will vary depending on how the system is configured and on the type of network on which the system is implemented. For example, a user may direct the terminal 44a to the server 42 (e.g., using a web browser and an Internet connection) and browse through the information files 62a-62d. In an IPTV network, on the other hand, the server may provide the terminal 44a with a listing of the available data files 48 for displaying to the user, e.g., a listing of television show episodes or movies. The user chooses one of the listed shows/movies, and the terminal 44a automatically accesses the server 42, without user involvement, for obtaining the information file 62a-62d associated with the user's programming choice. Alternatively, instead of having to access the server after the user chooses a data file/program, the listing could include the information files along with the program choices.

One or more of the terminals 44a-44d may also securely automatically transmit accounting data 70, relating to the amount of data transferred over the network 46 and/or the data transfer rate(s), to the tracker module 66, which forwards it to the server 42 for billing purposes. The accounting data 70 may also include an indication of which data file sections 52a-52d have finished downloading and are ready to be downloaded by other terminals.

The system 40 of the present invention is suitable for implementation in conjunction with various types of communication networks 46 over which multimedia content data files 48 may be transferred, including stand-alone networks and interconnected networks. For example, the network(s) 46 may include wire-line networks such as DSL networks, public switched telephone networks (PSTN), IP (Internet protocol)-based networks such as the Internet or other packet data networks, local area networks (LAN), and wireless networks such as those using CDMA, GSM, IEEE 802.11x, and/or UMTS communications or the like. The terminals 42, 44a-44d are electronic devices capable of communicating with one another over the network(s) 46, and as noted above may include, for example, computers, IP/network television units wire-line connected communication devices such as conventional telephones and enhanced/multimedia-capable telephones, and/or wireless units such as mobile phones, wireless PDA's, wireless devices with high-speed data transfer capabilities, such as those compliant with “3-G” or “4-G” standards, “WiFi”-equipped computer terminals, and the like. The terminals 42, 44a-44d communicate with one another over the network 46 in a standard manner, depending on the network 46, the particular protocols used for communicating over the network, and the type of terminals used for accessing the network. In the case of computer terminals and an IP network, one terminal (e.g., a client terminal) sends a request for data to another terminal (e.g., a server terminal), and data from the server terminal is transferred back to the client terminal in packet form. For example, for accessing a website on the Internet, a user may enter a URI (uniform resource identifier)/URL (uniform resource locator) or IP address of the website into a web browser software program running on the user's computer terminal, e.g., Microsoft Internet Explorer™. The URL is a string of characters conforming to a standardized format, which refers to a resource on the Internet (such as the home page of the website) by its location, and which may specify the protocol to use to communicate, the host/server to communicate with, the network communication port on the server to connect to, and the path to the resource on the server (for example, its file name). Once the URL is entered, the server terminal is contacted and, if available, the server terminal transmits requested data back to the user's terminal, according to the particular URL. For example, if the URL corresponds to a website home page, data corresponding to the home page (typically in HTML format), as stored on the server, is transmitted back to the user's terminal. The data is translated/decoded by the web browser to recreate the webpage in graphical form on the user terminal's display.

The server terminal 42 is a standard server-configured terminal (or grouping of terminals) having communication means for communicating over the network, e.g., one or more standard network interface cards/modules, modems, or the like. The server terminal 42 also includes mass storage or other memory, which may be organized into one or more databases 72 for storing the accounts 60a-60c and information files 62a-62d. The server terminal 42 may also include an interface or interface module 74 for users to access the server 42 (from the client terminals 44a-44d) to establish accounts and the like. For example, the interface 74 may be an Internet website implemented in a standard manner as well known in the art, e.g., HTML code. The exact type of interface 74, and whether an interface is provided at all, will depend on the desired configuration for the system 40. For example, in an IPTV network the user interface may exist solely on the client/peer terminals 44a-44d, which would be configured to allow a user to set up an account, select data files, and the like. (Information entered into a client terminal 44a-44d would then be transmitted back to the server for permanent storage and other use.)

To establish an account 60a on the server for peer-to-peer file transfer, a user at a client terminal 44a accesses the interface 74. For example, if the interface 74 is an Internet website or the like, the user would activate a web browser program on the client terminal 44a and enter a URL of the interface 74 into the web browser. Having accessed the interface 74, the user is provided with options such as “establish new account” and “access existing account.”The user is also provided with information about the system 40, including billing options and rates. If the “establish new account” option is selected, the user is prompted to enter personal information and whatever other information is required for establishing the account, e.g., name, billing address, e-mail address, payment means such as bank account debit or credit card, and security information such as user name and password. This information is stored in a standard manner as one or more associated files in the database 72, as the user's account 60a. To subsequently access the account 60a, the user accesses the interface 74, selects the “access existing account” function (or the like), and enters the account and/or security information. Again, as noted above, the user interface may be implemented on the client terminals, with the account information being transmitted to the server for storage and other use. Accounts may be established in other manners, such as a user communicating orally with a service provider representative over a telephone or in a store or other business.

The server terminal 42 also includes the information files 62a-62d stored in the database 72, or otherwise accessible to the server terminal 42. The information files 62a-62d each correspond to a different data file 48 available for download/transfer on the system 40. (In other words, each data file 48 has a corresponding information file 62a-62d stored on the server 42.) Each information file 62a-62d includes the network address or other location 64 of a tracker module 66, e.g., a URL or IP address of the tracker module for accessing the tracker module over the network 46. The tracker module 66, as further described below, may be general purpose in nature, e.g., the tracker module is used in conjunction with more than one data file 48, or it may be individually dedicated or assigned to the data file 48. The information files 62a-62d further include information 76 about their respective associated data files 48, such as file name, file type, file size, subject matter and content summary, and billing information such as rates for obtaining the file, if applicable. For example, in the case of a television program episode, the file information 76 could include the file name, the name of the television show, identifying information of the particular episode, a plot summary, a cast listing, reviews, play length, file size, file type, and the cost for downloading the data file. The information files may also contain hash data 68 relating to the data file sections 52a-52d.

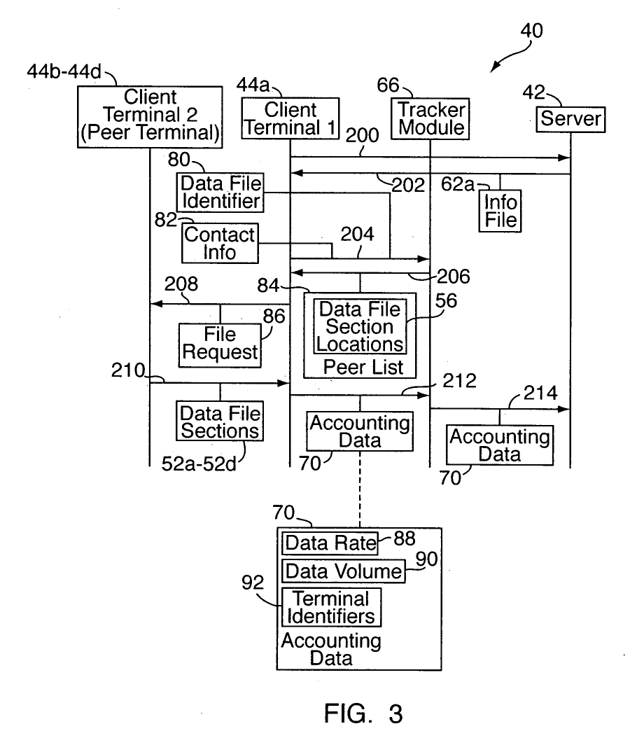

As an initial step in downloading a data file 48 or section 52a-52d thereof, a user directs the client terminal 44a to access the server 42 through the interface 74, as at Step 200 in FIG. 3, selects the “access existing account” option or the like, and enters the information required for accessing the user's account 60a. Subsequently, the user selects an option for selecting and/or downloading data files. Selecting a data file 48 may involve searching for the data file using key words or the like, searching for categories or groups of files, entering a file name or other identifier, if known, or browsing through a list or selection of available data files, possibly broken down by category, type, or genre. As such, the interface 74 may be provided with functionality for this purpose, such as a standard website search function, various linked web pages for browsing, one or more indices, or the like. Once a particular data file 48 is selected, the user selects a “download” function or the like, and may be asked to approve the billing rate or fee for downloading the file. Then, at Step 202 the information file 62a associated with the selected data file 48 is transferred from the server terminal 42 to the client terminal 44a over the network 46.

Alternatively, the client terminal 44a may obtain a listing of the data files 48 available through the system 40, which is displayed to the user. The user selects a desired data file, and the client terminal 44a contacts the server for obtaining the information file associated with the user-selected data file. It is also possible that the listing of available data files could include the data files' information files, which would allow a user to access the data file information 76 for use in deciding which data file to choose for downloading and viewing. Other configurations are possible.

The information file 62a is used for purposes of contacting and communicating with the tracker module 66 identified in the information file 62a. For this purpose, the client terminal 44a will typically be provided with a client module 78. The client module 78 is a hardware, hardware/software, or software application/program running on the client terminal 44a and configured to communicate over the network 46 in a standard manner, e.g., the client module 78 accesses the client terminal's network communication means (network interface card, modem, etc.) to send and receive messages and other data over the network 46. The client module 78 may be a utility-like software program operating in the “background” of the client terminal user interface or operating system, and/or it may provide user-accessible functionality such as displaying download status, download history, and the like. It may also function as a client terminal-based interface, for accessing the functionality of the server terminal 42 or otherwise. For obtaining the client module, the client module 78 may be downloaded from the server 42 when a user first establishes an account. The client module 78 is then installed onto the client terminal in a standard manner. Downloading and installing the client module may be required for using the system 40. Alternatively, the client module may be “built into” a client terminal. For example, in the case of a wireless unit or IP/network television unit, the client module could be provided as one of the standard available functions on the unit.

Once the information file 62a is received at the client terminal 44a, at Step 204 the client module 78 initiates communication with the tracker module 66 at the tracker module address/location 64 provided in the information file 62a. In particular, the client module 78 transmits a data file identifier 80 to the tracker module 66 and the tracker module responds with a peer list 84 of which terminals have the data file sections 52a-52d. The data file identifier 80 uniquely identifies the selected data file 48, and will typically be part of the data file information 76 in the information file 62a. For example, the data file identifier may be the file name of the data file, a serial or index number of the data file, or the like. In some systems, the client terminal 44a may also transmit contact information 82 to the tracker module. The client terminal contact information 82 includes whatever information is required for the tracker module 66 to communicate with the client terminal 44a, such as the network address of the client terminal (URL or IP address) and/or the communication port to which the client terminal is listening.

The tracker module 66 is a network-connected software- and/or hardware-based program/application, acting as an agent of the server terminal, for carrying out certain communication and other functions of the system 40. For example, the tracker module 66 may be provided for facilitating peer-to-peer contact for peer-to-peer data file transfer, for collecting accounting data 70 for billing purposes, and/or for tracking which terminals have obtained which data file sections 52a-52d over the system. The tracker module 66 implements a simple communication protocol layered on top of HTTP (that is, implemented to operate in conjunction with the communication protocol in place on the network, such as HTTP) in which a client terminal sends the file identifier 80, and the tracker module responds with the peer list 84 containing the network locations/addresses 56 of client/peer terminals 44b-44d having the data file sections 52a-52d of the selected data file 48. The terminals identified in the peer list 84 may have previously downloaded (or be in the process of downloading) the data file sections through the system 40, with the server terminal 42 and/or tracking module 66 having tracked information to that effect for subsequent peer-to-peer downloads initiated by other client terminals. (In other words, when a client terminal downloads a file section over the system, the server may be configured to note that the client terminal now has the file section available for peer-to-peer download, including storing the client terminal's network address for later providing to client terminals desiring to obtain the data file section.) Alternatively, the data file may originate with one of the identified peer terminals 44b-44d, with that identified peer terminal having notified the server terminal 42 (e.g., from the client module, and/or by accessing the interface 74) that the data file portions are available for peer-to-peer transfer. (As should be appreciated, in this case the client module would be configured to split the file into file sections 52a-52d.) Measures may be put in place at the server terminal 42 for safeguarding copyright-protected files.

As noted, there may be one tracker module/application 66 used for all peer-to-peer transactions, or, since transaction volume may require more than one tracker module, there may be a plurality of tracker modules 66 that are assigned to transactions as needed. Alternatively, there may be a tracker module 66 associated with each data file 48, with the tracker module being dedicated for transactions involving that data file. In such a case, it would not be necessary for a client terminal to transmit the file identifier 80 to the tracker module. Instead, the data file for downloading would be implied by the client terminal having contacted the particular tracker module. The tracker module(s) 66 may be stored on the server terminal 42 or on another network-connected terminal.

When the tracker module 66 receives the identifier 80 of a selected data file 48 and/or client module contact information 82 from a client terminal 44a, the tracker module 66 responds by sending a peer list 84 to the client terminal 44a, as at Step 206. The peer list 84, as noted, contains a list of the network addresses/locations 56 of one or more peer terminals having the data file sections 52a-52d. These may be all or some subset of the terminals having the data file sections 52a-52d on the system 40, or only those terminals currently in active communication with the network. Subsequently, the client module 78 (running on the client terminal 44a) selects one or more of the peer terminals from which to obtain the file sections 52a-52d. The selection may simply be the first active terminal(s) listed in the peer list, or the active peer terminal(s) “closest” to the client terminal 44a on the network 46. Other selection criteria are possible. Peer-to-peer file transfer commences once the peer terminals have been selected, e.g., peer terminals 44b-44d. In particular, at Step 208 the client module 78 initiates communication with each selected peer terminal 44b-44d over the network 46 at the location/address 56 of the peer terminal 44b-44d provided in the peer list 84. For example, this may include transmitting a peer-to-peer file request message 86 to each peer terminal 44b-44d. In response, at Step 210 the client module in place on each selected peer terminal 44b-44d causes the selected data file section 52a-52d, stored on the peer terminal 44b-44d, to be transmitted to the client terminal 44a in a standard manner.

How the data file sections 52a-52d are obtained will also depend on whether the user has selected the sequential transfer mode 58a or the random transfer mode 58b, if the client module 78 is provided with dual mode functionality. In the sequential transfer mode 58a, the user is able to view the multimedia content 50 in each file section as soon as the file section is received, and in logical sequential order of the multimedia content 50 in the file 48. This allows the user to start viewing the content without having to wait for the entire file 48 to download. For example, the user may want to view the initial portion of the content for evaluation purposes. In this mode, the data file sections 52a-52d are obtained in correspondence to the sequential order 54 (e.g., chronological order) of the multimedia content 50. In particular, the data file section 52a having the first sequential portion of the multimedia content 50 is the first to be obtained. As the file section 52a is obtained, or just after it is obtained (depending on data/file format), the file section 52a is executed for playback of the multimedia content 50 therein. During playback, the other file sections 52b-52d making up the file 48 are obtained, in sequential order one after the other, and are executed as soon as they are received (or as soon as playback of the prior file section is complete). Downloading will be halted if the user decides against viewing the entire program/multimedia content. As should be appreciated, each file section 52a-52d will have some sort of identifier/data indicating its sequential position in terms of the multimedia content 50, for the terminal 44a to determine the proper downloading sequence when in the sequential transfer mode 58a.

In the random transfer mode 58b, the data file sections 52a-52d are obtained irrespective of the sequential order of the multimedia content, that is, the sequential order of the content is not taken into account, and the data file sections 52a-52d may be obtained “out of order.” This mode is useful for users who do not require real time playback of the content 50, since it might result in faster transfer/download times. Initiation of file transfer is carried out as described above according to a “random” selection process, and the data file portions 52a-52d are received at the client terminal 44a. Typically, the selection process will not be truly random, but will instead be pseudo-random, or based on factors not relating to file content such as location in the network, available bandwidth, or the like. The data file portions 52a-52d are stored without playback, for retrieval and subsequent use. For example, the file portions may be verified and re-assembled into the data file 48 according to the hash information/data 68 made available to the client terminal 44a.

During or subsequent to file section transfer, and at least periodically, the client modules 78 in place on the selected peer terminals 44b-44d and client terminal 44a may each transfer accounting data 70 to the tracker module 66 (Step 212). The accounting data 70 includes data 88 relating to data transfer rates of the transferred data file portion(s), data 90 relating to the volume of data transferred, and data 92 identifying the terminals 44a-44d and/or the accounts 60a-60c associated with these terminals. Typically, the transfer rates will be used for statistical purposes, and the data volumes will be used for traffic recording for billing purposes, e.g., billing may be based on the amount of data transferred as opposed to the rate of transfer. Alternatively, users may select a burst transfer rate, which would be billed at a higher rate, or the accounting data may simply indicate that a file has been successfully transferred, if billing is on a per-file basis. Accounting data may be generated and/or used in terms of both upload and download volumes, the latter referring to data received at the requesting client terminal 44a and the former referring to data transferred by the peer terminals 44b-44d. Upload volumes may be used as a basis for billing credits for peer terminals, e.g., peer terminals may, in effect, be paid or credited a small amount for acting as data sources in the system 40, thereby providing an incentive for users of peer terminals to consent to subsequent file transfer to other peer terminals. Typically, the accounting data 70 will be transmitted to the tracker module and/or server terminal in a secure manner such as symmetric encryption, for ensuring that the accounting data is not modified by the user of the client terminal 44a. As should be appreciated, in this manner the generation and transmission of accounting data is performed automatically and without the possibility of user intervention, with use of the client module (and compartmentalized/secure generation of accounting data) being a prerequisite for using the system for peer-to-peer file transfer. Additionally, because each peer user is required to establish a secure account and to use the client module, a secure/trusted peer-to-peer network is established wherein the collection of fees for peer-to-peer data traffic is ensured.

If the accounting data 70 is transmitted to the tracker module 66, the tracker module forwards the data 70 to the server terminal 42, as at Step 214. The server terminal 42 uses the accounting data 70 to generate billing data 96a-96c. By “billing data,” it is meant information/data relating to monetary or similar charges (e.g., credits or debits) applied against a user or user account. Thus, the billing data 96a-96c may be based on the data transfer rates 88 and/or volumes 90, and may include, for example, monetary charges to or against the account(s) identified in, or determinable from, the accounting data 70. For example, if billing rates are based on data volume 90, then an account 60a may be charged a dollar amount as follows:

$charge=(data volume)×($/unit data)

This information is stored as the billing data 96a-96c in the users' respective accounts 60a-60c, with funds being obtained by the system 40 in a standard manner according to the user agreement and account type, e.g., a direct banking account debit, a credit card charge, or the like. Funds collected by the system 40 may be used to pay for copyright licensing fees, and to pay the network service provider for network bandwidth. Funds may be collected in other manners, e.g., a monthly rate, with the accounting data possibly being generated for statistics purposes, premium services, upload credits, and the like.

As noted, each time a peer terminal obtains a particular data file section, the network address or other location of that terminal is tracked by the tracker module 66 and/or server terminal 42 in association with the data file or data file section. In other words, the tracker module and/or server stores data (e.g., in a database or other storage) associating the address/location of the peer terminal with the data file section(s), as an indication that the peer terminal has the data file section(s) available for peer-to-peer transfer. In later obtaining the data file, the database or other storage is searched or otherwise accessed, in relation to the data file, to compile a relevant peer list 84 of the data file sections. Inclusion in the peer list may depend on whether the terminal is in communication with the network, and as such the tracker module and/or server terminal may perform a test for this condition. Alternatively, a client terminal can select an alternative peer terminal on the peer list if one is found to be unavailable for file transfer.

The system 40 may be provided with encryption and/or anti-copying measures whereby the data file sections 52a-52d may only be transferred to others through the system 40. For example, the system could be configured such that each time a data file section is copied or transferred, the file section either automatically self-encrypts or is automatically encrypted by the client module, with the client modules 78 having functionality 98 for decrypting the file for use. Thus, users would be prevented from transferring the data file sections 52a-52d (or data files 48) in a useable form outside the system 40, which might result in copyright infringement, violation of licensing contracts, or the like.

For file transfer in the system 40, data files 48 having multimedia content 50 (e.g., audio/video content such as an episode of a television show) are each split into a number of portions or sections 52a-52d for distribution among the peer terminals 44a-44d. By “distribution,” it is not necessarily meant that upon creating the file sections 52a-52d the server terminal disperses the file sections among the client terminals 44a-44d, but rather, more typically, that the file sections 52a-52d become distributed/dispersed after numerous server-to-client and peer-to-peer transfers. For example, upon initially creating the file sections, the file sections may lie on the server terminal 42. When a client terminal 44a initiates download of the data file 48 associated with the file sections 52a-52d for the first time, the file sections are transferred to the client terminal. In subsequent peer-to-peer transfers, additional terminals obtain the data file sections. At some of the terminals, fewer than all of the file sections in the data file may be obtained, e.g., if the user halts file transfer. Thus, after numerous transfers the file sections are distributed among the terminals, with some terminals having all the file sections of a data file, some terminals having a subset thereof, and some terminals having none of the data file sections.

With reference to FIG. 2C, in splitting or dividing a data file 48 into a plurality of data file sections 52a-52d, at least some of the data file sections are increased in size in correspondence to the sequential order 54 of the multimedia content 50, e.g., the data file sections containing the first sequentially-ordered portions of the multimedia content are smaller than those containing the later sequentially-ordered portions of the multimedia content. Thus, the size of each file section 52a-52d increases according to the chronological or other sequential order 54 of the multimedia content 50, such that the first data file section 52a (with the first sequential portion of the content, e.g., the beginning of a television show) is sized at the smallest level of the data file sections, and the last data file portion 52d (with the last sequential portion of the content, e.g. the end of the television show) is sized at the largest level of the data file sections. As noted above, by “smallest level,” it is meant that there may be other data file sections of the same size, but none smaller, and by “largest level” it is meant that there may be other data file sections of the same size, but none larger. Typically, the data file portions 52a with the first sequential multimedia content will be the smallest, and the last data file portion the largest. However, with reference to FIG. 2D, it is possible that the data file sections could be grouped into sections, with the data file sections in each group being the same size. (Box sizes are meant to represent relative file size.)

The size of each data file section 52a-52d may be based on a linear increase function 100. The linear increase function 100 is an algorithm whose inputs include the size of the data file 48 and the specified number of data file sections 52a-52d (which is a system parameter). As outputs, the function 100 produces a file size for each file section 52a-52d, linearly varying from a smallest level (for the file portions containing the first sequential portions of the multimedia content) to a largest level (for the file portions containing the end sequential portions of the multimedia content). The server terminal 42 uses the function outputs to divide or split the data file 48 into file portions 52a-52d, including possibly appending file format and other configuration data to the file portions. (In other words, if a data file is divided directly into unaltered pieces/sections, the pieces may not include all the proper header and other file formatting information required for using the data for playback or the like.)

The data file portions 52a-52d may originate with the server terminal 42, as noted above. For example, multimedia content data files 48 could be cleared for copyright licensing purposes, and then stored on the server terminal 42. The first time a client terminal requested to download the file 48, the file 48 would be split into file sections (if not done previously), and the file sections would be transferred from the server terminal to the downloading client terminal, in a manner similar to as described above, e.g., the server terminal would function, in effect, like a peer terminal. Alternatively, instead of file sections being stored on and transferred from the server terminal 42 itself, there could be a dedicated “peer” server 102, configured to function in a manner like a true peer terminal 44a-44d for storing and downloading data file sections 52a-52d in the first instance. The network address or other location of the peer server 102 would be provided in a peer list or the like, as described above. Subsequent to the data file sections 52a-52d being downloaded from the server 42 or peer server 102, the server 42 or peer server 102 would be excluded from subsequent peer lists, with the data file sections 52a-52d instead being transferred peer-to-peer. Alternatively, the server and/or peer server could act as a “backup” in case no peer terminals were available for downloading a particular data file section.

Although the tracker modules 66 facilitate an efficient division of communication functions in the system 40, the system 40 could instead be configured for operation solely with the server terminal or terminals 42, without departing from the spirit and scope of the present invention. Thus, the server terminal(s) could be configured for carrying out the functions of the tracker modules described above, with the client/peer terminals communicating directly with the server terminal(s) in all instances except for peer-to-peer file transfer.

As should be appreciated, although the data file sections 52a-52d have been characterized as portions or sections of a data file 48, each data file portion is itself a data file, e.g., grouping of data. As such, the data file portions may be characterized as data files, with the data file 48 being a larger, composite data file made up of the plurality of smaller data files or data file sections.

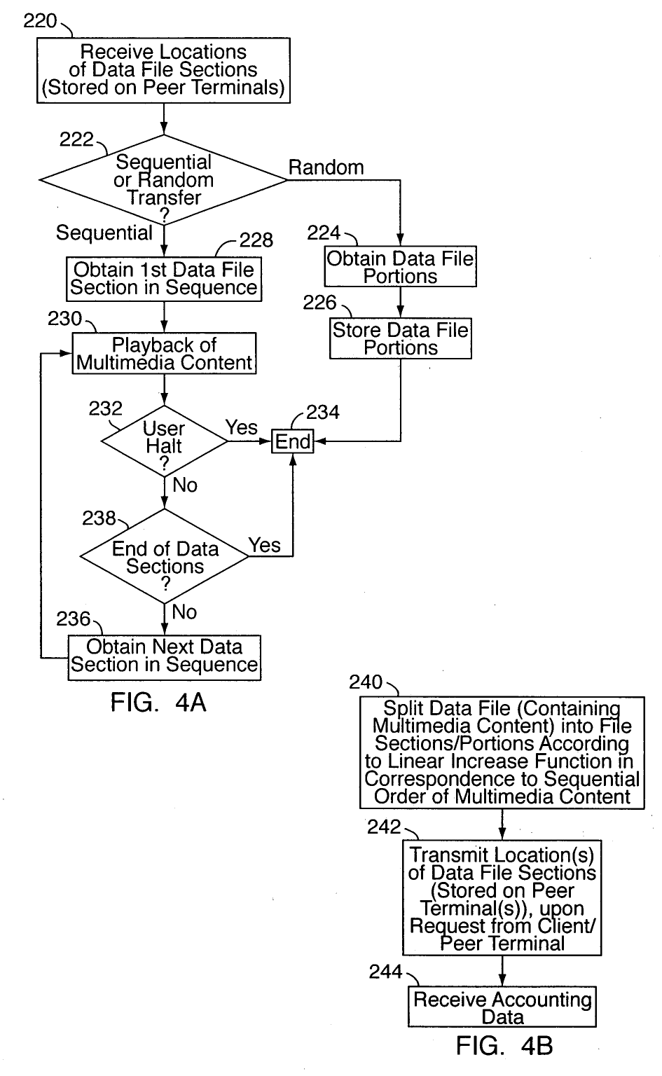

From the perspective of a client terminal 44a and/or client module 78, operation of an embodiment of the system 40 is summarized in FIG. 4A. At Step 220, the client terminal receives the network location(s) 56 of the data file sections 52a-52d that together form a selected multimedia content data file 48. The locations may be received from the tracker module/application 66 or the server terminal 42. Each location may be the network address or other location of the peer terminal 44b-44d on which the data file section is stored, or it may be an address or other location of the data file section itself, e.g., a sub-address or location on the peer terminal 44b-44d. At Step 222, it is determined if the user has selected the sequential transfer mode 58a or the random transfer mode 58b. If the latter, the data file portions 52a-52d are obtained over the network from the peer terminals 44b-44d without regard to the sequential chronological order of the data file 48's multimedia content, as at Step 224. The file portions are then stored on the terminal 44a at Step 226. If the former, the data file portions are obtained in correspondence to a sequential chronological or other sequential order of the multimedia content. Thus, at Step 228 the terminal 44a obtains the data file portion 52a that contains the first sequential portion of the multimedia content 50. The data file portion 52a is executed for playback of the multimedia content, as at Step 230. At Step 232, it is determined if the user has selected a “halt transfer” function or the like. If so, the process ends at Step 234. If not, the terminal obtains the next data file portion 52b that contains the next sequential portion of the multimedia content 50, as at Step 236. The process continues until the user halts the process or all the data file portions have been obtained (Step 238). If a user halts the process, the system 40 may be configured to either (i) automatically erase the downloaded sections, or (ii) to save the downloaded sections and subsequently continue transferring the sections to peer terminals unless the user selects otherwise.

The terminals 44a-44d may also transmit accounting data 70 to the tracker module/application 66 and/or to the server terminal 42. As noted, the accounting data 70 relates to the transfer of the data file sections between the peer terminals over the network, e.g., data transfer rates and/or data transfer volume. Typically, the accounting data will be automatically securely generated and transmitted during or subsequent to when the data file portions are obtained. In other words, upon transferring the data file portion, the transferring terminal and/or the receiving terminal automatically (e.g., without user input) and securely (e.g., without the possibility of user intervention) generate the accounting data and automatically and securely transmit it (e.g., secure transmission such as encryption) to the tracker module or server.

From the perspective of the tracker module 66 or server terminal 42, operation of an embodiment of the system 40 is summarized in FIG. 4B. At Step 240, the server terminal 42 splits a data file 48 (having multimedia content) into a plurality of data file sections 52a-52d for distribution among a number of peer terminals. At least some of said data file sections are increased in size in correspondence to a sequential order of the multimedia content. For example, the server may split the data file according to a liner increase function wherein the file section containing the first sequential portion of the multimedia content is the smallest and the file section containing the last sequential portion of the multimedia content is the largest. At Step 242, the server and/or tracker module transmits the network addresses or other locations of the file sections 52a-52d to a client terminal 44a, upon request from the client terminal 44a. Later, at Step 244, the server terminal and/or tracker module receives accounting data 70 from either or both the client terminal 44a and the peer terminals 44b-44d.

Although the system 40 has been illustrated as using a linear increase file split, it could instead utilize an “even split” method (e.g., each file section is about the same size) without departing from the spirit and scope of the invention.

In the system 40, a data file 48 may be divided into a large number of data file sections 52a-52d, e.g., thousands of file sections, which may be distributed among a large number of peer terminals 44b-44d. Because of the number of peer terminals involved, it may be impractical for the tracker module 66 to provide a downloading client terminal 44a with all the locations 56 at once. For example, if there are numerous peer terminals 44b-44d, it is possible that the peer list message 84 could be very large in size, as might slow down operation of the system. Additionally, the client terminal 44a may not have the capability or capacity to connect to all (or large numbers) of the other terminals at once for downloading file sections 52a-52d. Accordingly, the tracker module 66 may be configured to select a limited number of the peer terminal locations 56 (e.g., a subset of the locations of all the peer terminals having data file sections 52a-52d for a data file 48) for providing to the client terminal 44a, based on the downloading terminal's mode of operation.

In particular, if the client terminal 44a is in the sequential mode 58a, the tracker module 66 may be configured to provide the client terminal 44a with a subset of the total data file locations 56, which correspond to first sequential sections 52a, 52b of the data file. (For example, if there are 200 locations 56 in total, the first 100 locations could be provided.) The client terminal 44a obtains the first sections 52a, 52b as described above. The tracker module 66 is informed of the status of the client terminal's download by way of the periodic data volume report 90 in the accounting data 70, or through a similar mechanism. When the client terminal 44a is finished downloading, or soon before that time, the tracker module 66 provides the client terminal 44a with the remaining data file locations 56, which correspond to next sequential sections 52c, 52d of the data file. The client terminal 44a then obtains the next sections 52c, 52d in a manner as described above. This process may be repeated depending on the number of file locations transmitted from the tracker module 66 to the client terminal 44a in each instance.

If the client terminal 44a is in the random mode 58b, the tracker module 66 will provide the client terminal 44a with a subset of the total data file locations 56, which correspond to random locations/sections of the data file. (For example, if there are 200 locations 56 in total, 100 of these locations could be provided in a random or pseudo-random fashion.) Downloading occurs as described above, with the tracker module 66 tracking what file sections the client terminal has obtained. Subsequently, the tracker module transmits the remaining file locations to the client terminal 44a, by way of one or more additional peer list transmissions or the like. Typically, there will be no need for the tracker module 66 to provide the locations of file sections that the client terminal 44a has already obtained.

An embodiment of the present invention may be characterized as a data transfer system 40 for a network. The system 40 includes a client application 78 configured to obtain a plurality of data file portions 52a-52d from at least one peer terminal 44b-44d over the network 46. The data file portions 52a-52d together form a data file 48 having multimedia content 50. The client application 78 includes an option 58a for a sequential transfer mode, wherein the data file portions 52a-52d are obtained in correspondence to a sequential chronological order 54 of the multimedia content 50. The client application 78 also include an option 58b for a random transfer mode, wherein the data file portions 52a-52d are obtained irrespective of the sequential chronological order 54 of the multimedia content 50.

Since certain changes may be made in the above-described peer-to-peer file download system for IPTV network, without departing from the spirit and scope of the invention herein involved, it is intended that all of the subject matter of the above description or shown in the accompanying drawings shall be interpreted merely as examples illustrating the inventive concept herein and shall not be constructed as limiting the invention.

We claim:

1. A method for transferring data over a network, said method comprising the steps of:
transmitting, to a client terminal, network locations of a plurality of data file sections which were distributed among a plurality of peer terminals and which collectively form a data file having multimedia content, wherein at least some of said data file sections are increased in size in correspondence to a sequential order of the multimedia content.

2. The method of claim 1 wherein:
the network locations are transmitted upon request of the client terminal, for the client terminal to obtain the data file sections from the peer terminals over the network.

3. The method of claim 2 further comprising:
receiving accounting data originating from at least one of said client terminal and said peer terminals, said accounting data relating to a transfer of said data file sections from the peer terminals to the client terminal over the network.

4. The method of claim 3 wherein:
the locations of said data file sections are transmitted to the client terminal from at least one of a server terminal and a tracker module, wherein at least one of said server terminal and said tracker module is in communication with at least one of said client terminal and said peer terminals over the network; and
the accounting data is received by at least one of said server terminal and said tracker module.

5. The method of claim 4 wherein:
the accounting data is received by said tracker module; and
the method further comprises transmitting the accounting data from the tracker module to the server terminal for billing purposes.

6. The method of claim 3 further comprising:
establishing a secure connection with said at least one of the client terminal and the peer terminals for securely receiving said accounting data there from.

7. The method of claim 6 wherein the accounting data includes at least one of a rate at which each data file section was transferred over the network and an amount of data in each of said data file sections.

8. The method of claim 1 further comprising:
splitting the data file into the plurality of data file sections.

9. The method of claim 8 wherein:
a first of said data file sections having a first chronological portion of said multimedia content is sized at the smallest level of said data file sections; and
another of said data file sections having a last chronological portion of said multimedia content is sized at the largest level of said data file sections.

10. The method of claim 8 wherein the size of said plurality of data file sections is based on a linear increase function in correspondence to the sequential order of the multimedia content, whereby a first of said data file sections having a first chronological portion of said multimedia content is sized at the smallest level of said data file sections, and another of said data file sections having a last chronological portion of said multimedia content is sized at the largest level of said data file sections.

11. A method for transferring data over a network, said method comprising the steps of:
receiving network locations of a plurality of data file portions which in combination form a data file having multimedia content,
wherein a first one of said data file portions has a first chronological portion of said multimedia content and is sized at a smallest level of said plurality of data file portions, at least some of the other data file portions being larger in size than the first data file portion.

12. The method of claim 11 further comprising:
obtaining at least the first data file portion over the network from at least one peer terminal based on said network locations.

13. The method of claim 12 wherein the size of said plurality of data file portions increases linearly in correspondence to a sequential chronological order of the multimedia content of said data file.

14. The method of claim 12 wherein:
the locations are received from at least one of a server terminal and a tracking application associated with the server terminal; and
the method further comprises transmitting accounting data to at least one of the tracking application and the server terminal, said accounting data relating to the transfer of said first data file portion by said at least one peer terminal over the network.

15. The method of claim 14 wherein the accounting data is automatically securely generated and transmitted during or subsequent to said first data file portion being obtained.

16. The method of claim 14 further comprising:
accessing a secure account on said server terminal; and
accessing a database on said server terminal from said account to select an information file associated with the data file, said information file including a location of the tracking application for obtaining the locations of the data file portions from the tracking application, wherein said information file is one of a plurality of information files on said server terminal each relating to a different multimedia data file available for download.

17. A method for transferring data over a network, said method comprising the steps of:
obtaining a plurality of data file portions from at least one peer terminal over the network, said data file portions together forming a data file having multimedia content;
said data files portions being obtained according to a selected one of a sequential transfer mode, wherein the data file portions are obtained in correspondence to a sequential chronological order of the multimedia content, and a random transfer mode, wherein the data file portions are obtained irrespective of the sequential chronological order of the multimedia content.

18. The method of claim 17 wherein in the sequential transfer mode a first data file portion to be obtained has a first chronological portion of said multimedia content and is sized at the smallest level of said plurality of data file portions.

19. The method of claim 18 wherein the first data file portion is executed for playback of said first chronological portion of said multimedia content substantially immediately upon obtaining said first data file portion.

20. The method of claim 17 wherein in the random transfer mode each of said plurality of data file portions is stored after being obtained, for subsequent playback of the multimedia content of said data file once all of said plurality of data file portions are obtained.
